(19) United States
(12) Patent Application Publication
(10) Pub. No.: US 2017/0010407 A1
(43) Pub. Date: Jan. 12, 2017

(54) Displays With Multimode Backlight Units

(71) Applicant: Apple Inc., Cupertino, CA (US)

(72) Inventors: Yi Huang, Santa Clara, CA (US); Jun Qi, Cupertino, CA (US); Rong Liu, Sunnyvale, CA (US); Victor H. Yin, Cupertino, CA (US); Xinyu Zhu, Cupertino, CA (US)

(21) Appl. No.: 14/878,944

(22) Filed: Oct. 8, 2015

Related U.S. Application Data
(60) Provisional application No. 62/190,607, filed on Jul. 9, 2015.

(51) Int. Cl. F21V 8/00; H05B 37/02

(52) U.S. Cl. CPC G02B 6/0068; G02B 6/0073; G02B 6/0025; G02B 6/0046; G02B 6/0076; H05B 37/0218

(57) ABSTRACT

A display may have a backlight unit that provides backlight illumination. The backlight unit may include a light guide that distributes light through the display. The light guide may include opposing first and second edges. A first light source such as a first row of light-emitting diodes may emit light into the first edge and a second light source such as a second row of light-emitting diodes may emit light into the second edge. In a normal viewing mode, both light sources are active and backlight illumination is provided over a normal range of angles. In a restricted angle-of-view mode, only one light source is active and backlight is emitted in a more concentrated fashion over a restricted range of angles. In a high luminance restricted angle-of-view mode, the active light source is driven at an elevated level.

This application claims the benefit of provisional patent application No. 62/190,607 filed on Jul. 9, 2015, which is hereby incorporated by reference herein in its entirety.

### BACKGROUND

This relates generally to electronic devices with displays, and, more particularly, to backlit displays.

Electronic devices often include displays. Some displays contain arrays of light-emitting diodes that emit light to display images for a user. Other types of displays such as liquid crystal displays, microelectromechanical systems (MEMS) shutter displays, and electrophoretic displays include backlight units. A backlight unit produces light that travels outwardly through an array of pixels in a display. The pixels modulate the intensity of the light from the backlight unit to create images on the display. Backlight units help ensure that displays such as liquid crystal displays and electrophoretic displays can display images in a wide variety of ambient lighting conditions.

The ability of a user to view an image on a backlit display may be affected by the brightness of the backlight illumination produced by the backlight unit. If the backlight illumination is too dim, images will be difficult to view, particularly in bright ambient lighting conditions. Care must be taken, however, to limit the amount of illumination that is produced, because backlight settings that produce high backlight illumination levels tend to increase power consumption and reduce battery life.

It would therefore be desirable to be able to produce electronic device displays with improved backlight units.

### SUMMARY

A display may have a multimode backlight unit. An array of pixels in the display may be used to display images for a user. The backlight unit may provide backlight illumination for the array of pixels.

The backlight unit may include a light guide layer that distributes light laterally through the display. The light guide layer may include opposing first and second edges. A first light source such as a first row of light-emitting diodes may emit light into the first edge and a second light source such as a second row of light-emitting diodes may emit light into the second edge. In a normal viewing mode, both light sources are active and backlight illumination is provided over a normal range of angles. In a concentrated angle-of-view mode, only one light source is active and backlight is emitted in a more concentrated fashion over a restricted range of angles.

The light guide layer in the backlight unit may include one or more regions with light scattering features that are configured to primarily scatter light from the first row of light-emitting diodes and one or more regions that are configured to primarily scatter light from the second row of light-emitting diodes. These light-scattering features may be implemented as different regions on a single layer of light guide material or may be implemented on two respective layers of light guide material. In backlight configurations with a stack of two light guide layers, a first of the light guide layers may receive light from the first row of light-emitting diodes and a second of the light guide layers may receive light from the second row of light-emitting diodes.

### BRIEF DESCRIPTION OF THE DRAWINGS

FIG. 1 is a perspective view of an illustrative electronic device having a display in accordance with an embodiment.

FIG. 2 is a schematic diagram of an illustrative electronic device having a display in accordance with an embodiment.

FIG. 3 is a cross-sectional side view of an illustrative display in accordance with an embodiment.

FIG. 4 is a cross-sectional side view of an illustrative display with a multimode backlight unit being used in a wide viewing angle mode in accordance with an embodiment.

FIG. 5 is a cross-sectional side view of an illustrative display of the type shown in FIG. 4 being used in a reduced-viewing-angle reduced-power mode in accordance with an embodiment.

FIG. 6 is a cross-sectional side view of an illustrative display of the type shown in FIG. 5 being used in a reduced-viewing-angle elevated-luminance mode in accordance with an embodiment.

FIG. 7 is a cross-sectional side view of an illustrative display with a multimode backlight in accordance with an embodiment.

FIG. 8 is a cross-sectional side view of an illustrative display with a multimode backlight based on two stacked light guide layers in accordance with an embodiment.

FIG. 9 is a cross-sectional side view of an illustrative backlight based on two light-guide layers with tapered sections in accordance with an embodiment.

FIG. 10 is a cross-sectional side view of an illustrative backlight based on a single light guide layer in accordance with an embodiment.

FIG. 11 is a top view a backlight unit including a light guide layer such as the light guide layer of FIG. 10 in accordance with an embodiment.

FIG. 12 is a top view of a portion of the light guide layer of FIG. 11 in accordance with an embodiment.

FIGS. 13 and 14 are cross-sectional side views of different light-scattering features for use in different portions of the light guide layer of FIG. 11 in accordance with an embodiment.

### DETAILED DESCRIPTION

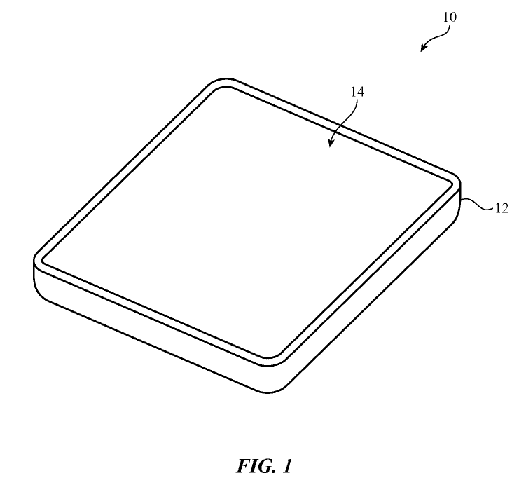

An illustrative electronic device of the type that may be provided with a display is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a computer display that does not contain an embedded computer, a computer display that includes an embedded computer, a gaming device, a navigation device, an embedded system such as a system in which electronic equipment with a display is mounted in a kiosk or automobile, equipment that implements the functionality of two or more of these devices, or other electronic equipment. In the illustrative configuration of FIG. 1, device 10 is a portable device such as a cellular telephone, media player, tablet computer, watch or other wrist device, or other portable computing device. Other configurations may be used for device 10 if desired. The example of FIG. 1 is merely illustrative.

In the example of FIG. 1, device 10 includes a display such as display 14 mounted in housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures. A touch sensor may be formed using electrodes or other structures on a display layer that contains a pixel array or on a separate touch panel layer that is attached to the pixel array (e.g., using adhesive).

Display 14 may include an array of pixels formed from liquid crystal display (LCD) components, an array of electrophoretic pixels, an array of electrowetting pixels, or pixels based on other display technologies. Configurations in which display 14 is a liquid crystal display with a backlight are sometimes described herein as an example. This use of liquid crystal display technology for forming display 14 is merely illustrative. Display 14 may, in general, be formed using any suitable type of pixels.

Display 14 may be protected using a display cover layer such as a layer of transparent glass or clear plastic. Openings may be formed in the display cover layer. For example, an opening may be formed in the display cover layer to accommodate a button, a speaker port, or other component. Openings may be formed in housing 12 to form communications ports (e.g., an audio jack port, a digital data port, etc.), to form openings for buttons, etc.

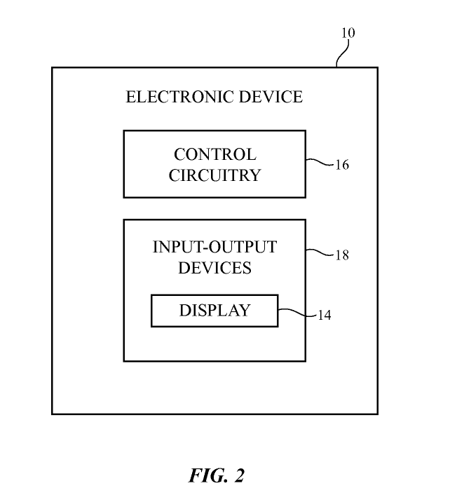

FIG. 2 is a schematic diagram of device 10. As shown in FIG. 2, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc.

Input-output circuitry in device 10 such as input-output devices 18 may be used to allow data to be supplied to device 10 and to allow data to be provided from device 10 to external devices. Input-output devices 18 may include buttons, joysticks, scrolling wheels, touch pads, key pads, keyboards, microphones, speakers, tone generators, vibrators, cameras, sensors (e.g., ambient light sensors, proximity sensors, orientation sensors, magnetic sensors, force sensors, touch sensors, etc.), light-emitting diodes and other status indicators, data ports, etc. A user can control the operation of device 10 by supplying commands through input-output devices 18 and may receive status information and other output from device 10 using the output resources of input-output devices 18. Input-output devices 18 may include one or more displays such as display 14.

Control circuitry 16 may be used to run software on device 10 such as operating system code and applications. During operation of device 10, the software running on control circuitry 16 may display images on display 14 using an array of pixels in display 14. While displaying images, control circuitry 16 may control the transmission of each of the pixels in the array and can make adjustments to the amount of backlight illumination for the array that is being produced by backlight structures in display 14. Control circuitry 16 may also direct display 14 to operate in a selected mode of operation (e.g., when display 14 has a multimode backlight). Mode adjustments may be made on ambient light sensor readings from an ambient light sensor in devices 18 or other suitable input.

Display 14 may have a rectangular shape (i.e., display 14 may have a rectangular footprint and a rectangular peripheral edge that runs around the rectangular footprint) or may have other suitable shapes. Display 14 may be planar or may have a curved profile.

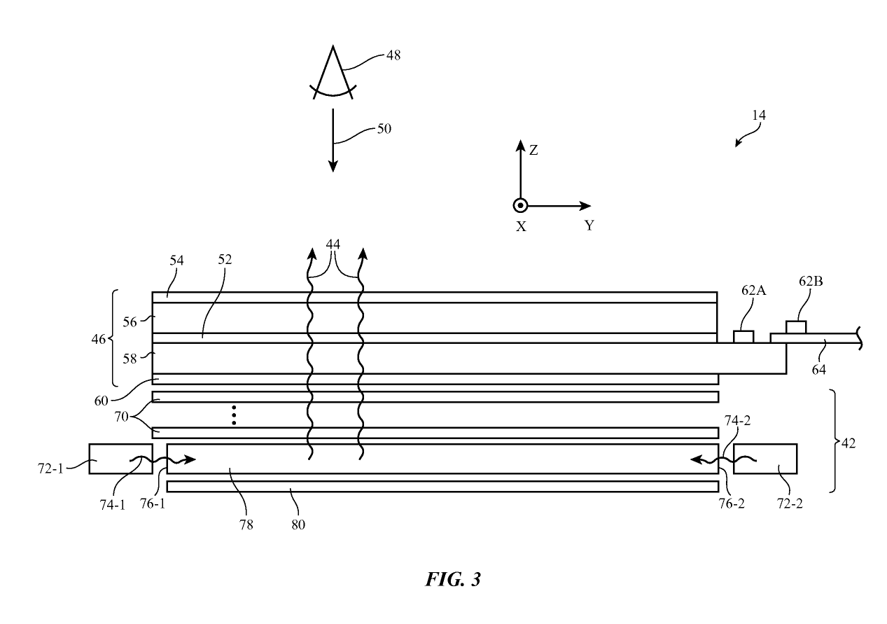

A cross-sectional side view of display 14 is shown in FIG. 3. As shown in FIG. 3, display 14 may include backlight structures such as backlight unit 42 for producing backlight illumination such as backlight 44. During operation, backlight 44 travels outwards (vertically upwards in dimension Z in the orientation of FIG. 3) and passes through display pixel structures in display layers 46. This illuminates any images that are being produced by the display pixels for viewing by a user. For example, backlight 44 may illuminate images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12). Display layers 46 may form a liquid crystal display or may be used in forming displays of other types.

In a liquid crystal display, display layers 46 may include a liquid crystal layer such a liquid crystal layer 52. Liquid crystal layer 52 may be sandwiched between display layers such as display layers 58 and 56. Layers 56 and 58 may be interposed between lower polarizer layer 60 and upper polarizer layer 54.

Layers 58 and 56 may be formed from transparent substrate layers such as clear layers of glass or plastic. Layers 58 and 56 may be layers such as a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of pixel circuits based on thin-film transistors and associated electrodes (pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer. Configurations in which color filter elements are combined with thin-film transistor structures on a common substrate layer in the upper or lower portion of display 14 may also be used.

During operation of display 14 in device 10, control circuitry (e.g., one or more integrated circuits on a printed circuit) may be used to generate information to be displayed on display 14 (e.g., display data). The information to be displayed may be conveyed to one or more display driver integrated circuits such as illustrative circuit 62A or illustrative circuit 62B using a signal path such as a signal path formed from conductive metal traces in a rigid or flexible printed circuit such as printed circuit 64 (as an example).

Backlight structures 42 may include a light guide layer such as light guide layer 78 (sometimes referred to as a light guide structure or light guide). Light guide layer 78 may be formed from one or more stacked layers of transparent material such as clear glass or plastic (e.g., molded plastic that forms a light guide plate, a thin flexible plastic film, etc.). During operation of backlight structures 42, light sources such as light source 72-1 and 72-2 may generate light that creates backlight 44. Light source 72-1 may be an array of light-emitting diodes that runs along left edge 76-1 of light guide layer 78 (i.e., into the page along the X axis in the orientation of FIG. 3). Light-source 72-1 may emit light 74-1 into left edge 76-1 of light guide layer 78. Light source 72-2 may be an array of light-emitting diodes that extends along right edge 76-2 of light guide layer 78 and that emits light 74-2 into edge 76-2 of light guide layer 78. Light 76-1 propagates to the right (positive Y direction) in light guide layer 78 and light 76-2 propagates to the left (negative Y direction) in light guide layer 78.

Light 74-1 and 74-2 may be distributed throughout light guide layer 78 due to the principal of total internal reflection. Scattering features (protrusions, recesses, etc.) may be incorporated into light guide layer 78 (e.g., on the upper and/or lower surface of layer 78) to scatter light from layer 78. Light that is scattered upwards in direction Z from light guide layer 78 may serve as backlight 44 for display 14. Light that scatters downwards may be reflected back in the upwards direction by reflector 80. Reflector 80 may be formed from a reflective material such as a layer of plastic covered with a dielectric minor thin-film coating. To enhance backlight performance for backlight structures 42, backlight structures 42 may include optical films 70. Optical films 70 may include diffuser layers for helping to homogenize backlight 44 and thereby reduce hotspots and light collimating films such as prism films (sometimes referred to as brightness enhancement films) and turning films for directing backlight 44 towards direction Z. Optical films 70 may overlap the other structures in backlight unit 42 such as light guide layer 78 and reflector 80. For example, if light guide layer 78 has a rectangular footprint in the X-Y plane of FIG. 3, optical films 70 and reflector 80 may have a matching rectangular footprint. If desired, films such as compensation films may be incorporated into other layers of display 14 (e.g., a reflective polarizer layer).

Light guide layer 78 may be configured so that backlight from left-hand light source 72-1 is angled slightly to the right of the surface normal of display 14 when emitted from display 14 and so that backlight from the right-hand light source 72-2 is angled slightly to the left of the surface normal when emitted from display 14. This allows display 14 to be operated in a variety of different backlight illumination modes.

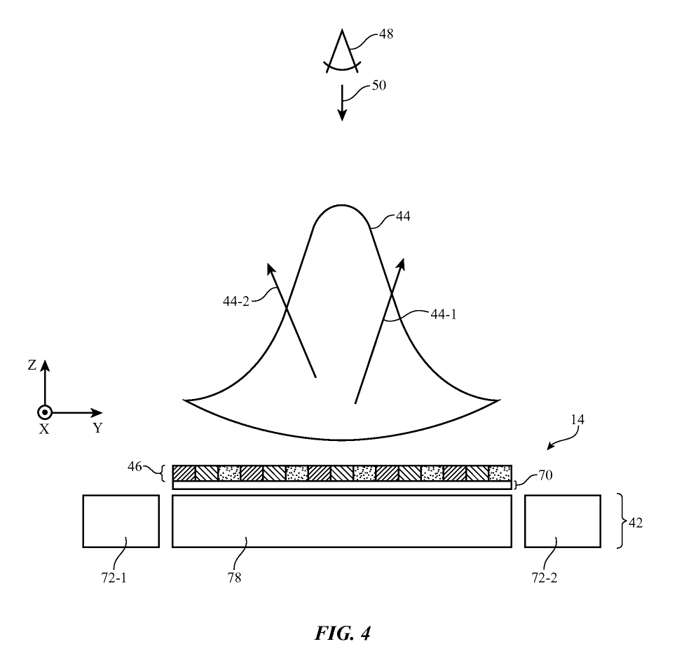

If a normal wide viewing angle is desired, both light source 72-1 and light source 72-2 of display 14 may be activated. In this situation, light source 72-1 may produce backlight illumination that is angled to the right such as backlight 44-1 of FIG. 4, whereas light source 72-1 may produce light that is angled to the left such as backlight 44-2 of FIG. 4. When both backlight 44-1 and backlight 44-2 are present, the overall distribution of backlight intensity for display 14 will be suitable for normal display operations (e.g., viewing angle will be +/−35° or +/−45° from the surface normal of the display or more), as illustrated by the wide shape of the illustrative output intensity profile for backlight 44 in FIG. 4.

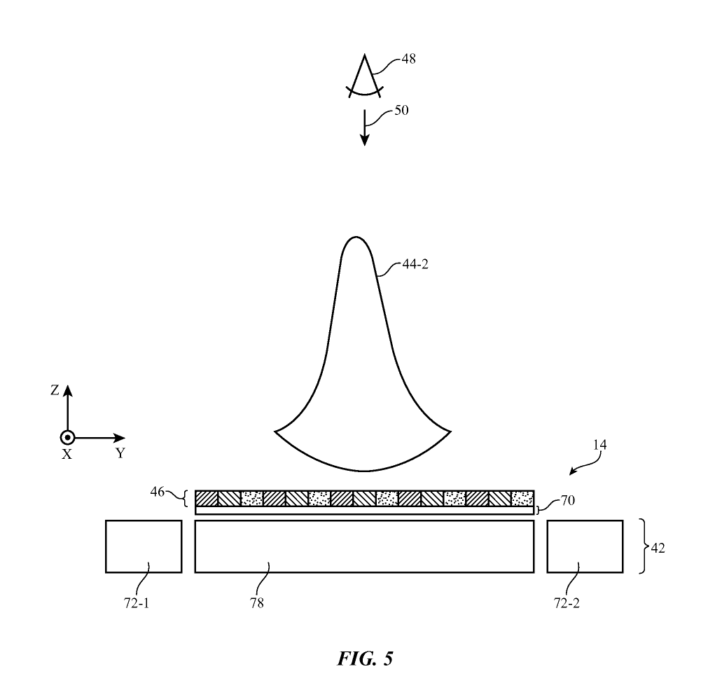

If it is desired to reduce power consumption, one of the light sources may be partly or fully turned off. As shown in FIG. 5, for example, light source 72-1 may be turned off, so that the only backlight illumination that is produced by backlight unit 42 is backlight 44-2 from light source 72-2. Because only half of the light sources in backlight unit 42 are active in this configuration (i.e., because light source 72-1 is off), power consumption is cut in half. Viewing angle is reduced, because only the left half of the backlight of FIG. 4 is being produced, but so long as user 48 is viewing display from an orientation that is aligned with the backlight illumination 44-2, display 14 will appear to have a satisfactory brightness (i.e., the luminance of the display will be at or close to its normal level).

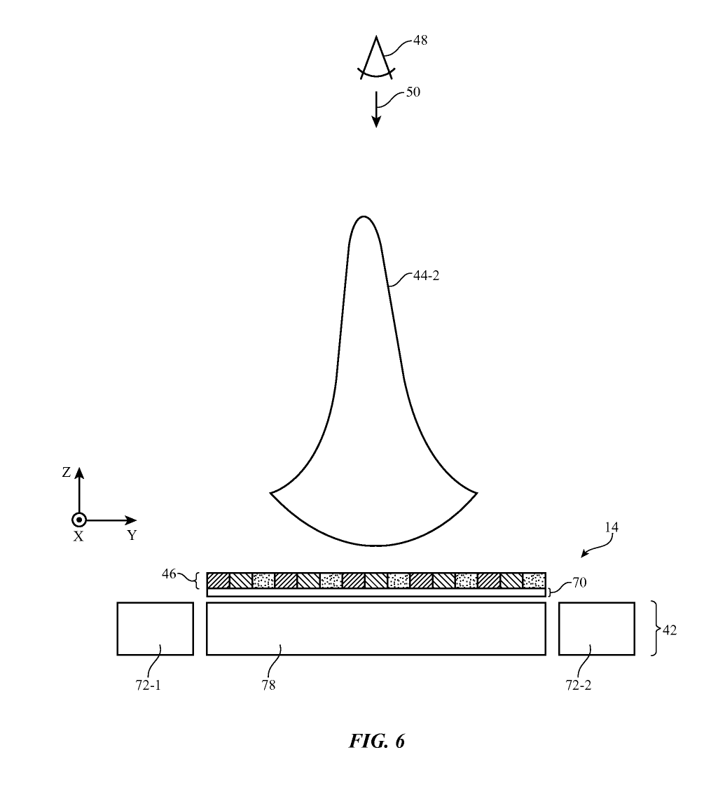

It is also possible to increase the drive current for the light-emitting diodes of light source 72-2 to increase display luminance, while maintaining light source 72-1 in an off configuration to conserve power. This type of scenarios is illustrated in FIG. 6. Because the angular spread of backlight 44-2 is not as wide as the angular spread of backlight 44 of FIG. 4 (which includes both backlight 44-2 and backlight 44-2), the angle-of-view for display 14 (i.e., the angle over which display 14 will emit light) will be more restricted than in the scenario of FIG. 4. However, because backlight 44-2 of FIG. 6 contains the same (or a similar amount) of light as backlight 44 of FIG. 4 while being more angularly concentrated than backlight 44 of FIG. 4, the luminance of display 14 will be enhanced (albeit only over the reduced angle of view). The enhanced luminance mode may be used when an ambient light sensor in device 10 detects that the ambient light level in which device 10 and display 14 is being used is elevated. By enhancing display luminance in these viewing conditions, display 14 may remain visible even in high ambient light levels without overly increasing the total amount of power consumed by backlight unit 42. In effect, backlight illumination is being used more efficiently by angularly concentrating the backlight illumination without increasing backlight power consumption.

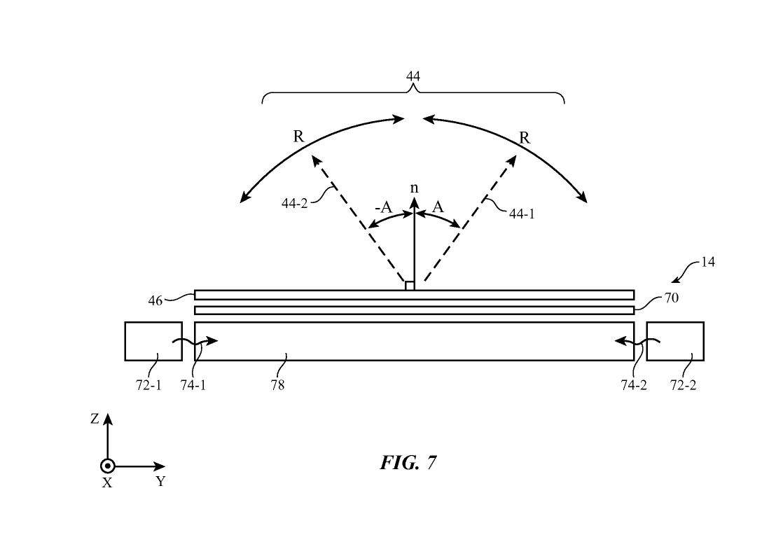

FIG. 7 is a cross-sectional side view of display 14 showing how backlight 44-1 and backlight 44-2 may each be spread over a range R of different angles with respect to surface normal n of display 14. Range R may be, for example, a value of about 10-45°, 15-90°, more than 25°, or other suitable angular range. Light 44-1 may be angled to the left (angle −A with respect to surface normal n) and light 44-2 may be angled to the right (angle A with respect to surface normal n), as illustrated in FIG. 7. The magnitude of angle A may be 10-20°, more than 5°, 5-30°, less than 50°, or other suitable angle. During operation of backlight unit 42 in a mode in which light sources 72-1 and 72-2 are both active, adjacent portions of light 44-1 and light 44-2 may overlap (e.g., in a range of angles around surface normal n).

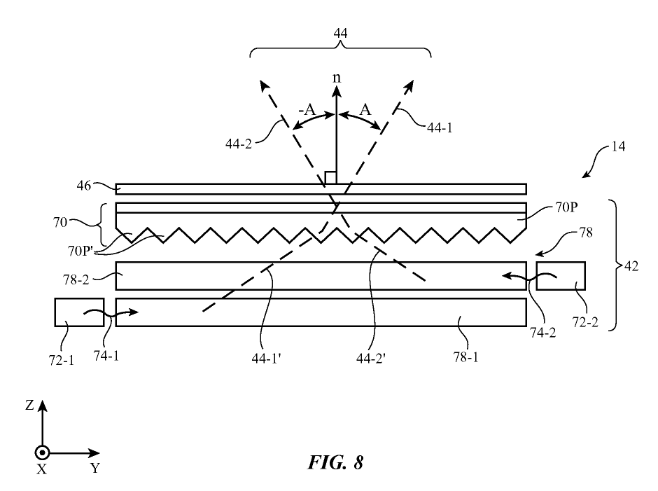

As shown in FIG. 8, optical films 70 may include turning film 70P. Turning film 70P may have a series of parallel ridges that protrude outwards from a planar transparent substrate (see, e.g., downwardly protruding ridges 70P′). Ridges 70P′ may run parallel to each other along the X axis in the orientation of FIG. 8 (as an example).

In the illustrative arrangement of FIG. 8, light guide layer 78 includes a stack of two separate light guide layers: layer 78-1, which receives light 74-1 from light source 72-1 and light guide layer 78-2, which receives light 74-2 from light source 72-2. Light 74-1 is scattered upwards as scattered light 44-1′ (e.g., at an angle of about 60-70° from surface normal n). Light 74-2 is scattered upwards as scattered light 44-2′ (e.g., at an angle of about −60 to −70° from surface normal n). Turning film 70P redirects light 44-1′ upwards as backlight 44-1 and redirects light 44-2′ upwards as backlight 44-2 (i.e., film 70P helps turn the scattered light from layers 78-1 and 78-2 towards a direction parallel to surface normal n to produce backlight 44). In the FIG. 8 configuration, light 74-1 that is injected into backlight unit 42 from the left becomes backlight 44-1 that is concentrated at positive non-zero angle A with respect to surface normal n (e.g., 10-20°, more than 10°, less than 20°, etc.), whereas light 74-2 that is injected into backlight unit 42 from the right becomes backlight 44-2 that is concentrated at comparable negative non-zero angle with respect to surface normal n (e.g., angle −A).

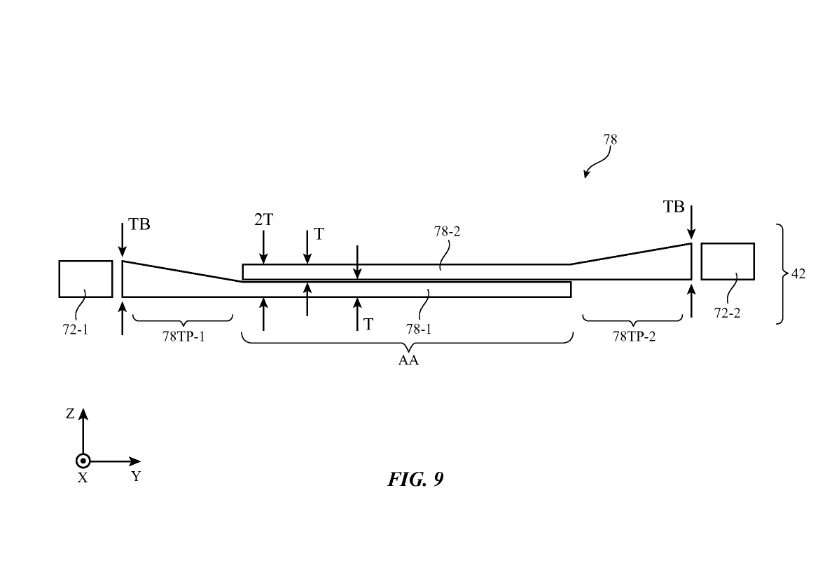

As shown in FIG. 9, light guide layers 78 in backlight unit 42 may be provided with tapered portions 78TP-1 (for light guide layer 78-1) and 78TP-2 (for light guide layer 78-2). The thickness of light guide plates 78-1 and 78-2 adjacent to respective light sources 72-1 and 72-2 may be TB. In central active area AA, the thickness of plates 78-1 and 78-2 may be reduced to a smaller thickness T by the tapered light guide portions, so that the total thickness 2T of light guide layer 78 is not larger than desired.

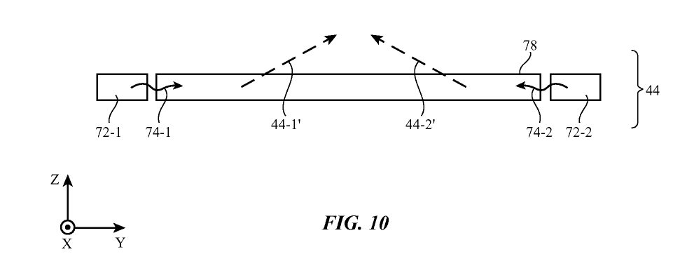

If desired, light guide layer 78 may be implemented using a single layer of material, as shown in FIG. 10. With this type of arrangement, light guide layer 78 may include some regions that have light-scattering features configured to scatter light 74-1 that is propagating to the right to produce scattered light 44-1′ and may include other regions that have light-scattering features configured to scatter light 74-2 that is propagating to the left to produce scattered light 44-2′.

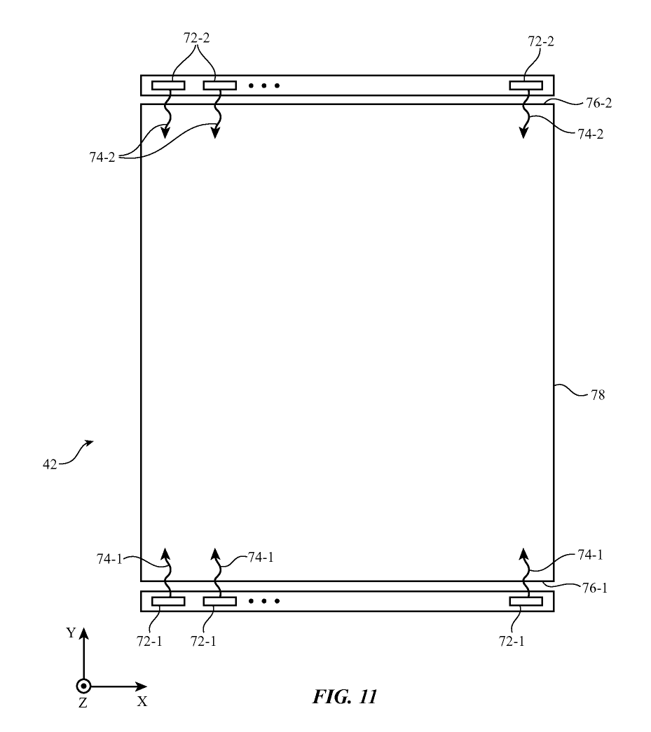

FIG. 11 is a top view of backlight unit 42. As shown in FIG. 11, light source 72-1 (a row of light-emitting diodes) emits light 74-1 into edge 76-1 of light guide layer 78 and light 74-1 travels in the positive Y direction within light guide layer 78. Light source 72-2 (a row of light-emitting diodes) emits light 74-2 into opposing edge 76-2 of light guide layer 78 and light 74-2 travels in the negative Y direction within light guide layer 78.

Layer 78 may have a first set of light-scattering features that are effective at extracting light 72-1 from layer 78 and a second set of light-scattering features that are effective at extracting light 72-2 from layer 78. The light-scattering features for extracting light 72-1 may not extract significant amounts light 72-2 and vice versa.

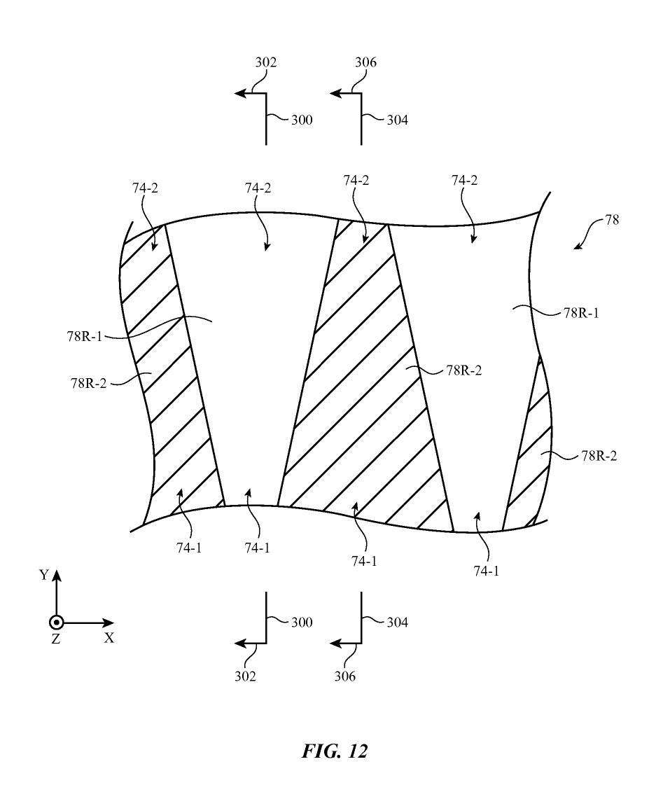

FIG. 12 is a top view of a portion of the single-layer light guide layer 78 of FIG. 10 showing how some regions of light guide layer 78 such as regions 78R-1 may contain light-scattering features that are used in extracting light 74-1 (but which may not extract significant amounts of light 74-2), whereas other regions of light guide layer 78 such as regions 78R-2 may contain light-scattering features that are used in extracting light 74-2 (but which may not extract significant amounts of light 74-1). The fraction of light guide plate 78 that is devoted to region 78R-1 (e.g., the percentage of the light guide plate area devoted to region 78R-1 in the example of FIG. 12) may be greatest along the edge of light guide plate 78 that is adjacent light source 72-2 and that is therefore farthest away from light source 72-1. Likewise, the fraction of light guide plate 78 that is devoted to the light-scattering features for light 74-2 may increase with increasing distance from light source 72-2. In the FIG. 12 example, the width of regions 78R-2 increases with increasing distance in the negative Y direction, whereas the width of regions 78-1 increases with increasing distance in the positive Y direction.

Using non-uniform distributions of light-scattering features (e.g., using the configuration of FIG. 12 or other suitable configuration) helps ensure that the amount of backlight illumination 44 that is produce is even across display 14. For example, by increasing the light-scattering features for light 74-1 as a function of increasing distance from light source 72-1 (i.e., by increasing the width of regions 78R-1 as a function of increasing distance in the positive Y direction or by otherwise increasing the density of the light-scattering features for light 74-1), the efficiency with which light 74-1 is extracted from light guide plate 78 increases at increasing distances from source 72-1, thereby compensating for the drop in the intensity of light 74-1 in layer 78 with increasing distances from source 72-1 that results from continually scattering light out of plate 78. The increasing density of light-scattering features for light 74-2 with increasing distance in the negative Y direction likewise compensates for the decrease in intensity of light 74-2 as a function of distance in the negative Y direction. Although the increase in density of light-scattering features for each of these types of light has been described in the context of using tapered regions such as tapered regions 78R-1 and 78R-2 in the example of FIG. 12, other patterns of light-scattering feature regions may be used to implement desired light-scattering feature gradients if desired.

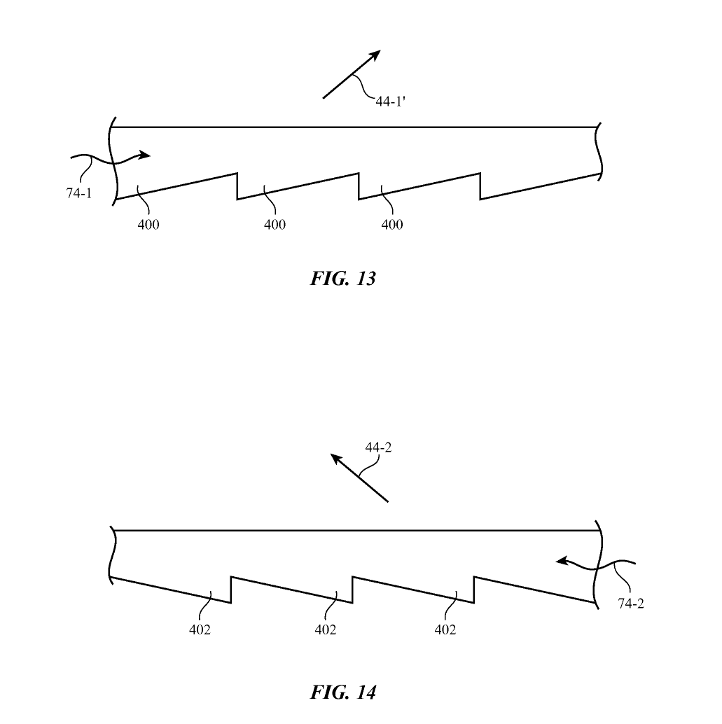

FIG. 13 is a cross-sectional side view of light guide plate 78 in one of regions 78R-1 (e.g., a cross-sectional side view of light guide plate 78 of FIG. 12 taken along line 300 and viewed in direction 302 of FIG. 12) showing an illustrative profile that may be used for light-scattering features 400 that are configured to help scatter light 74-1. FIG. 14 is a cross-sectional side view of light guide plate 78 in one of regions 78R-2 (e.g., a cross-sectional side view of light guide plate 78 of FIG. 12 taken along line 304 and viewed in direction 306 of FIG. 12) showing an illustrative profile that may be used for light-scattering features 402 that are configured to help scatter light 74-2. If desired, other types of light-scattering features may be used for regions 78R-1 and 78R-2. The shapes of features 400 and 402 of FIGS. 13 and 14 are merely illustrative. Moreover, features such as features 400 or other suitable features for extracting light 74-1 may be used in plates 78-1 and features such as features 402 or other suitable features for extracting light 74-2 may be used in plates 78-2 in stacked arrangements of the types shown in FIGS. 8 and 9. In this type of configuration, the density of features 400 in layer 78-1 of layer 78 may increase with increasing distance from source 72-1 and the density of features 402 in layer 78-2 of layer 78 may increase with increasing distance from source 72-2.

The foregoing is merely illustrative and various modifications can be made by those skilled in the art without departing from the scope and spirit of the described embodiments. The foregoing embodiments may be implemented individually or in any combination.

What is claimed is:

1. Apparatus, comprising:
display layers for a display that contain an array of pixels for displaying images, wherein the display layers have a surface normal; and
backlight structures for the display that provide backlight illumination that passes through the display layers, wherein the backlight structures include a first light source along one edge of a light guide layer and a second light source along an opposing edge of the light guide layer and wherein backlight from the first light source is concentrated at a positive non-zero angle with respect to the surface normal and wherein backlight from the second light source is concentrated at a negative non-zero angle with respect to the surface normal.

2. The apparatus defined in claim 1 further comprising control circuitry that operates the backlight structures in:
a first mode in which the first and second light sources are active and the backlight illumination includes the backlight from the first light source and the backlight from the second light source; and
a second mode in which the second light source produces more light than the first light source.

3. The apparatus defined in claim 2 wherein the control circuitry produces all of the backlight illumination with the second light source and turns the first light source off during the second mode.

4. The apparatus defined in claim 3 wherein the control circuitry produces backlight with the second light source during a third mode in which more of the backlight is produced with the second light source than during the second mode.

5. The apparatus defined in claim 4 wherein the light guide layer includes a first light guide layer that receives light from the first light source and a second light guide layer that receives light from the second light source.

6. The apparatus defined in claim 5 wherein the first and second light guide layers are stacked on top of each other.

7. The apparatus defined in claim 6 further comprising a turning film interposed between the light guide layer and the display layers.

8. The apparatus defined in claim 7 wherein the first and second light guide layers have tapers adjacent to the first and second light sources, respectively.

9. The apparatus defined in claim 8 wherein the display layers include a liquid crystal layer and wherein the first and second light sources comprise light-emitting diodes.

10. The apparatus defined in claim 4 wherein the light guide layer is a single layer of transparent material.

11. The apparatus defined in claim 10 wherein the light guide layer includes first regions with first light-scattering features that scatter light from the first light source and includes second regions with second light-scattering features that scatter light from the second light source and wherein the first and second light-scattering features have different profiles.

12. The apparatus defined in claim 11 further comprising a turning film interposed between the light guide plate and the display layers.

13. The apparatus defined in claim 12 wherein the display layers include a liquid crystal layer and wherein the first and second light sources comprise light-emitting diodes.

14. The apparatus defined in claim 13 wherein the first light-scattering features increase in density with increasing distance from the first light source and wherein the second light-scattering features increase in density with increasing distance from the second light source.

15. A display, comprising:
display layers that include an array of pixels for displaying images; and
a backlight unit that produces backlight illumination that passes through the display layers, wherein the backlight unit includes a light guide layer, a first light source along a first edge of the light guide layer, and a second light source along an opposing second edge of the light guide layer, wherein the light guide layer includes first light-scattering features that scatter light from the first light source and includes second light-scattering features that scatter light from the second light source, wherein the first light-scattering features increase in density with increasing distance from the first light source across all of the light guide layer, and wherein the second light-scattering features increase in density with increasing distance from the second light source across all of the light guide layer.

16. The display defined in claim 15 wherein the first light-scattering features scatter light from the first light source more efficiently than light from the second light source and wherein the second light-scattering features scatter light from the second light source more efficiently than light from the first light source.

17. The display defined in claim 16 wherein the light guide layer is formed from a single layer of transparent material.

18. The display defined in claim 16 wherein the light guide layer includes a first light guide layer that receives light from the first light source and that contains the first light-scattering features and includes a second light guide layer stacked on the first light guide layer that receives light from the second light source and that contains the second light-scattering features.

19. An electronic device, comprising:
an array of pixels that display images;
control circuitry; and
backlight structures that provide backlight illumination for the array of pixels, wherein the backlight structures include a light guide having opposing first and second edges, a first light source that emits light into the first edge, and a second light source that emits light into the second edge, wherein the control circuitry operates the backlight structures in at least a normal mode in which the first and second light sources produce light and an restricted angle-of-view mode in which the first light source produces light while the second light source does not produce light.

20. The electronic device defined in claim 19 further comprising an ambient light sensor that measures an ambient light level, wherein the control circuitry operates the backlight structures in a selected one of the normal mode and the restricted angle-of-view mode based at least partly on the ambient light level.
